(19) United States
(12) Patent Application Publication
(10) Pub. No.: US 2010/0279890 A1
(43) Pub. Date: Nov. 4, 2010

(54) FUSION GENE MICROARRAY

(75) Inventors: Ragnhild A. Lothe, Oslo (NO); Guro E. Lind, Oslo (NO); Rolf I. Skotheim, Oslo (NO); Gard O.S. Thomassen, Oslo (NO); Torbjørn Rognes, Oslo (NO)

Correspondence Address: KNOBBE MARTENS OLSON & BEAR LLP, 2040 MAIN STREET, FOURTEENTH FLOOR, IRVINE, CA, 92614, US

(73) Assignee: OSLO UNIVERSITETSSYKEHUS HF, Oslo (NO)

(21) Appl. No.: 12/664,537

(22) PCT Filed: Jun. 27, 2008
(86) PCT No.: PCT/EP2008/058272

§ 371 Date: Mar. 25, 2010

(30) Foreign Application Priority Data
Jun. 27, 2007 (DK) PA 2007 00930
Jun. 27, 2007 (EP) 07111167.8
Mar. 7, 2008 (DK) PA 2008 00335

(51) Int. Cl. C40B 30/04; C40B 40/06

(52) U.S. Cl. 506/9; 506/16

(57) ABSTRACT

The present invention relates to a microarray comprising a chimeric probe for an intergenic exon-to-exon junction of a fusion gene and at least two intragenic probes for a fusion gene partner of the fusion gene. The invention further relates to a method of detecting a fusion gene and a kit suitable for detecting fusion genes.

### BACKGROUND

Cancer genomes often contain fusion genes, created after structural chromosomal rearrangements such as translocations, deletions, and inversion. Fusion genes are typically found in haematological cancers. So far, fusion genes have been found only rarely associated with solid tumours, in contrast to detection of numerous genomic copy number imbalances. However, recent reports have shown that fusion transcripts may prove to be a common contributor also to the development of solid tumours (Mitelman et al., 2007, Teixeira, 2006, Tomlins et al., 2005). The main problem has been the technological limitations for detection of fusion genes in solid tumours.

Identification of certain fusion genes are currently performed for differential diagnosis or therapeutic decision-making in haematological cancers and some rare solid tumour types. At present, routine diagnostics laboratories use laborious and inefficient analyses for detection of fusion genes in clinical samples. The tests are typically cytogenetic chromosome analyses (karyotyping—usually by Giemsa banding) and/or RT-PCR of a selection of the most common fusion genes covering the most common break points for the individual novel transcript. To obtain metaphase chromosomes for karyotyping, a considerable amount of fresh tissue material is required, which also need to contain living and dividing cells. This methodology is also time consuming and labour intensive, and yet only has a success rate of about 70 percent. Furthermore, it is necessary to have highly experienced and competent personnel to examine the chromosomes visually, providing subjective results that also are at low-resolution. RT-PCR is a focused method, enabling analysis of one or a few candidate fusion genes at the time, at pre-defined fusion break points within them. The major limitation of this method is that it is not genome-wide, and thus a negative finding is not conclusive.

### BACKGROUND ART

There have been a few reports trying to identify predetermined fusion genes by oligo microarrays targeting specific junction sequences. These relied on a preceding step with amplification of the probes by RT-PCR, specifically targeting a small selection of predefined fusion genes and individual junction sequences therein. Similarly, junction oligos between exons in the same gene have been used for detection of alternative splicing.

Nasedkina et al., 2002, used multiplex RT-PCR followed by microarrays for identification of PCR products containing specific fusion transcripts. Their microarray contained probes for detection of up to two fusion variants of each of four well-known fusion genes. PCR amplification was performed as a nested two-round multiplex reaction with specific primers. Thus, their method and microarrays was designed for identification of only a few predetermined gene fusions.

Nasedkina et al., 2003 expanded on the above findings to include probes targeting one additional fusion gene, and 247 cases of childhood leukaemia were screened. Again, the authors only aimed at identification of predetermined fusion genes, more specifically fusion genes of clinical relevance for childhood leukaemia.

Shi et al., 2003 used multiplex RT-PCR for amplification of seven fusion genes and subsequently used oligo microarrays to identify the PCR product, i.e. oligos targeting one or two sites per fusion gene. As with Nasedkina et al., 2002, Nasedkina et al., 2003, their analysis was limited to a rather small number of predetermined fusion genes that are known to have an association with leukaemia. The authors claim that their method is quantitative, as opposed to the method of Nasedkina et al., 2002, Nasedkina et al., 2003. Further, Shi et al., 2003 mention on page 1069 that “Although multiplex RT-PCR with 10-20 primer pairs was ideal, our preliminary data indicated that multiplex RT-PCR with primer pairs in excess of 20 was achievable with substantial assay optimization effort. However, the probability that formation of non-specific PCR products and primer-dimers would increase with increasing numbers of primers limited the maximum number of primer pairs”. Thus, they acknowledge an unmet demand for higher throughput of the analysis and suggest that more than one multiplex RT-PCR can be devised to encompass more than 40 fusion transcripts. Further, the authors on page 1072 mention that “Because some of the translocation fusion splice junction sites may be a few kilobases distant from the 3′ poly(A) tail on the mRNA, use of microarray assay alone is not possible at this stage because the reverse transcriptase is unable to generate cDNA long enough to reach the fusion splice-junction site”. In other words, sequence specific RT-PCR is necessary for the assay to function, which in turn limits the throughput of the method for the reasons mentioned above.

Use of oligo microarrays in the analysis of pre-mRNA splicing patterns have previously been described in for example Bingham et al., 2006, Johnson et al., 2003.

US 2006/0084105 describes a microarray comprising sets of probes for detection of gene products that are produced by pre-mRNA splicing of a selected gene. The array comprises 372 splice junctions within 64 genes.

US 2006/012952 and WO 03/014295 also relate to the use of microarrays for detection of pre-mRNA splice variants.

### DETAILED DESCRIPTION OF THE INVENTION

### Brief Description of the Drawings

FIG. 1. Microarray data pattern for a positive fusion gene hit. A) This illustrative example of a fusion gene has a crossing over event between sequences in intron 2 in gene A and intron 3 in gene B. An intergenic exon-to-exon junction, A2-B4, probe (oligo), detects the fusion transcript. B) If the genes A and B both have 10 exons, the microarray will contain 10×10=100 probes (oligos) to cover all exon-to-exon junction combinations for this particular fusion gene. The A2-B4 probe (oligo) detects the fusion transcript from part A. C) The longitudinal profiles of intragenic probes for each exon and exon-to-exon junction will provide support for true events of fusion genes.

FIG. 2. Microarray data pattern for a prostate cancer sample comprising a TMPRSS2:ERG fusion gene. The left-most picture shows the results which were obtained with the chimeric exon-to-exon junction probes. In this picture the X-axis indicates each of the exons of the TMPRSS2 gene while the Y-axis indicates each of the exons of the ERG gene. Hence the left-most picture shows that the chimeric exon-to-exon probes corresponding to a fusion transcript between exon 1 of TMPRSS2 and exon 4 of ERG are producing strong signals. The rightmost picture shows expression level of each of the exons in the ERG gene as detected with the intragenic probes.

FIG. 3. Microarray data for the cell line RCH-ACV which is known to contain a TCF3:PBX1 fusion gene. This figure shows similar to FIG. 2 the results obtained with the chimeric exon-to-exon probes capable of hybridising to TCF3:PBX1 fusion gene (top picture) and the relative expression level of the individual exons of the TCF3 and PBX1 gene (bottom, left and right picture, respectively) as detected with intragenic probes for each of the two genes.

### SUMMARY OF THE INVENTION

In a first aspect, the invention provides a microarray comprising a chimeric probe for an exon-to-exon junction of a fusion gene.

A second aspect of the invention is a method for detection of fusion genes and a third aspect of the invention is a kit comprising the microarray of the invention.

### DISCLOSURE OF THE INVENTION

A first aspect of the invention is a microarray comprising a chimeric probe for an exon-to-exon junction of a fusion gene.

The microarray of the present invention may in particular further comprise at least two intragenic probes for a fusion gene partner of the fusion gene.

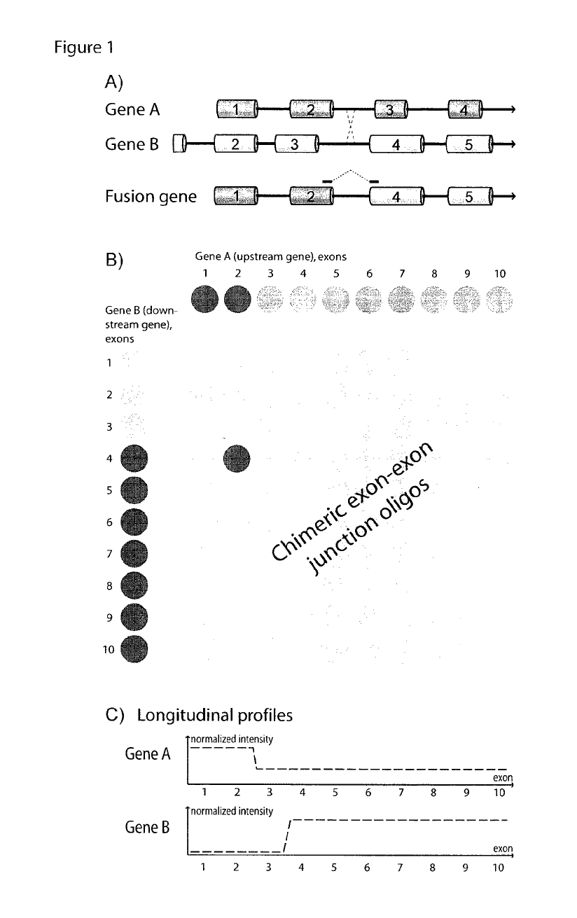

An advantage of including intragenic probes is that the likelihood of false-positive results is reduced. The intragenic probes provide exon level data on the gene expression, thus enabling comparisons of expression levels up- and downstream of suspected breakpoints of potential fusion gene partners. At the point where the expression level of the exons shift as illustrated in FIG. 1C this is were one fusion gene partner is fused to the other fusion gene partner. Hence the result of the intragenic probes may be used to corroborate the results found with the chimeric probes so as to reduce the likelihood of picking up false-positives from the chimeric exon-to-exon junction probes.

Another advantage of using the intragenic probes is that they may be used to indicate previously unidentified fusion genes.

The intragenic probes may in particular correspond to intra-exon sequences, exon-to-exon junctions, exon-intron junctions and intron-exon junctions of a fusion gene partner of the fusion gene. Such intragenic probes may be used to determine the expression level of fusion genes and/or fusion gene partners. In a preferred embodiment, intragenic probes are used in varying amounts or lengths in separate spots to facilitate quantification and comparison.

In a particular embodiment, the at least two intragenic probes are capable of targeting each side of the fusion break point; i.e. the intragenic point where one fusion gene partner is fused to another fusion gene partner

The microarray of the present invention may in particular comprise at least 2 intragenic probes, such as at least 3 intragenic probes, or at least 4 intragenic probes, or at least 5 intragenic probes, or at least 6 intragenic probes, or at least 7 intragenic probes, or at least 8 intragenic probes, or at least 9 intragenic probes, or at least 10 intragenic probes, or at least 20 intragenic probes, or at least 30 intragenic probes, or at least 40 intragenic probes, or at least 50 intragenic probes, or at least 75 intragenic probes, or at least 100 intragenic probes, or at least 500 intragenic probes, or at least 1000 intragenic probes.

In particular the microarray of the present invention comprises at least two intragenic probes for each of the fusion gene partners of a fusion gene. If the microarray of the present invention is able to detect more than one fusion gene said microarray may comprise a different number of intragenic probes for each of the fusion genes. For example said microarray may comprise at least two intragenic probes for both fusion gene partners of one fusion gene and at least two intragenic probes for only one fusion gene partner of another fusion gene.

In particular the microarray of the present invention comprises a chimeric probe and at least two intragenic probes which target the same fusion gene. In particular the microarray of the present invention may comprise at least two intragenic probes for each of the included fusion genes. More particularly the microarray of the present invention may comprise at least two intragenic probes for each of the included fusion gene partners. In this context the term “included” refers to the fusion gene or fusion gene partner that said microarray is intended to be capable of detecting by comprising chimeric probes for.

In one embodiment of the present invention the microarray of the present invention comprises intragenic probes for each of the included fusion gene partners. In particular the microarray of the present invention may include three intragenic probes per exon, and said intragenic probes may in particular be targeting exon-to-exon junctions.

Preferably, the microarray comprises intragenic probes corresponding to all exons, exon-to-exon junctions, exon-intron junctions and intron-exon junctions of the individual fusion gene partners of the microarray.

Even more preferably, the microarray comprises 2, 3, 4, or 5 intragenic probes corresponding to each exon of the individual fusion gene partners of the microarray.

An intragenic probe as used herein is a nucleic acid or a nucleic acid analogue, capable of sequence-specific base pairing. The intragenic probe may consist of or comprise natural nucleotides or non-natural nucleotides such as LNA monomers (locked nucleic acid monomers), INA monomers (intercalating nucleic acid monomers), or PNA monomers (peptide nucleic acid monomers).

Preferably, the microarray of the invention comprises intragenic probes targeting fusion gene partners of more than one fusion gene. For example the microarray of the present invention may comprise intragenic probes for at least 2 fusion genes, such as at least 5 fusion genes or at least 10 fusion genes, or at least 20 fusion genes, or at least 30 fusion genes, or at least 50 fusion genes, or at least 75 fusion genes, or at least 100 fusion genes, or at least 250 fusion genes or at least 500 fusion genes, or at least 1000 fusion genes. Thus, in a preferred embodiment, the microarray of the invention comprises intragenic probes for a number of the fusion genes listed in Table 1, selected from the group consisting of at least 5 fusion genes, at least 10 fusion genes, at least 20 fusion genes, at least 30 fusion genes, at least 40 fusion genes, at least 50 fusion genes, at least 75 fusion genes, at least 100 fusion genes, at least 150 fusion genes, at least 200 fusion genes, at least 250 fusion genes, at least 275 fusion genes and at least 316 fusion genes.

The intragenic probes may be either antisense probes oriented to hybridise to mRNA or double-stranded cDNA, or sense probes being oriented to hybridise to cDNA of the fusion genes. Thus, the term “corresponds” as used in this context refers to either the same sequence or the complementary sequence.

The microarray may comprise both antisense and sense intragenic probes, i.e. it may be useful for hybridisation with both cDNA and mRNA or both strands of a PCR product.

The intragenic probes may be probes capable of hybridising to an exon sequence or they may be capable of hybridising to an intragenic junction sequences; e.g. exon-to-exon junctions, exon-intron junctions or intron-exon junction. If the intragenic probe is for a intragenic junction sequence it may preferably be isothermic, i.e. the intragenic junction sequence probe for each side of the junction may be adjusted in length to have a melting temperature (Tm value) that differs by at most 20 degrees Celsius when hybridised to a complementary DNA sequence under the conditions employed for hybridisation of the microarray. In other embodiments, the Tm values differ by at most 40 degrees Celsius 35 degrees, Celsius 30 degrees Celsius, 25 degrees Celsius, 15 degrees Celsius, and 10 degrees Celsius, respectively. Isothermic probes are favourable to enable good hybridisation conditions across the complete set of probes (oligonucleotides) on the microarray.

Moreover, the first part and the second part of such intragenic junction sequence probes are preferably adjusted in length to have a Tm value that differs at most 10 degree Celsius under the conditions employed for hybridisation of the microarray. In other embodiments, the Tm values differ by at most 16 degrees Celsius, 14 degrees Celsius, 12 degrees Celsius, 8 degrees Celsius, 6 degrees and 4 degrees Celsius.

Adjustment of the Tm value of a probe or part of a probe may be achieved as described below in relation to the chimeric exon-to-exon probes.

The Tm value of the intragenic probes may preferably be selected from the group consisting of more than 45 degrees Celsius, more than 50 degrees Celsius, more than 55 degrees Celsius, more than 60 degrees Celsius, more than 65 degrees Celsius, more than 70 degrees Celsius and more than 75 degrees Celsius.

The length of the intragenic probes are preferably selected from the group consisting of less than 60 nucleotides, less than 55 nucleotides, less than 50 nucleotides, less than 45 nucleotides, less than 40 nucleotides and less than 35 nucleotides.

The microarray of the present invention may in particular be for detection of a fusion gene.

The fusion gene may be any fusion gene. Preferably, at least one of the fusion gene partners has previously been implicated as part of a verified fusion gene. More preferably, the fusion gene is selected from the group consisting of the following known fusion genes,

TABLE 1
Fusion genes, with the Ensembl gene IDs for each
of the 316 pairs of fusion gene partners

| Gene A | Gene B |
|---|---|
| ENSG00000009709 | ENSG00000150907 |
| ENSG00000010404 | ENSG00000197021 |
| ENSG00000015133 | ENSG00000113721 |
| ENSG00000015133 | ENSG00000134853 |
| ENSG00000023445 | ENSG00000172175 |
| ENSG00000029725 | ENSG00000113721 |
| ENSG00000047410 | ENSG00000105976 |
| ENSG00000047410 | ENSG00000198400 |
| ENSG00000047932 | ENSG00000047936 |
| ENSG00000054118 | ENSG00000129204 |
| ENSG00000066455 | ENSG00000165731 |
| ENSG00000066629 | ENSG00000097007 |
| ENSG00000067369 | ENSG00000113721 |
| ENSG00000067955 | ENSG00000133392 |
| ENSG00000069399 | ENSG00000136997 |
| ENSG00000071564 | ENSG00000105619 |
| ENSG00000071564 | ENSG00000108924 |
| ENSG00000071564 | ENSG00000185630 |
| ENSG00000072274 | ENSG00000113916 |
| ENSG00000072864 | ENSG00000113721 |
| ENSG00000073921 | ENSG00000078403 |
| ENSG00000077150 | ENSG00000059377 |
| ENSG00000078674 | ENSG00000096968 |
| ENSG00000078674 | ENSG00000165731 |
| ENSG00000080824 | ENSG00000113916 |
| ENSG00000082805 | ENSG00000165731 |
| ENSG00000083168 | ENSG00000005339 |
| ENSG00000083168 | ENSG00000100393 |
| ENSG00000083168 | ENSG00000140396 |
| ENSG00000083168 | ENSG00000143970 |
| ENSG00000089280 | ENSG00000123268 |
| ENSG00000089280 | ENSG00000157554 |
| ENSG00000089280 | ENSG00000157613 |
| ENSG00000089280 | ENSG00000166986 |
| ENSG00000089280 | ENSG00000175197 |
| ENSG00000089280 | ENSG00000175197 |
| ENSG00000089280 | ENSG00000182158 |
| ENSG00000096384 | ENSG00000113916 |
| ENSG00000100345 | ENSG00000171094 |
| ENSG00000100503 | ENSG00000113721 |
| ENSG00000100815 | ENSG00000113721 |
| ENSG00000103522 | ENSG00000113916 |
| ENSG00000105662 | ENSG00000184384 |
| ENSG00000105810 | ENSG00000078403 |
| ENSG00000105810 | ENSG00000085276 |
| ENSG00000105810 | ENSG00000118058 |
| ENSG00000105810 | ENSG00000164438 |
| ENSG00000108091 | ENSG00000113721 |
| ENSG00000108091 | ENSG00000165731 |
| ENSG00000108821 | ENSG00000100311 |
| ENSG00000108821 | ENSG00000129204 |
| ENSG00000108946 | ENSG00000165731 |
| ENSG00000109220 | ENSG00000139083 |
| ENSG00000109471 | ENSG00000048462 |
| ENSG00000109906 | ENSG00000131759 |
| ENSG00000110092 | ENSG00000070404 |
| ENSG00000110619 | ENSG00000171094 |
| ENSG00000110713 | ENSG00000005073 |
| ENSG00000110713 | ENSG00000024862 |
| ENSG00000110713 | ENSG00000040633 |
| ENSG00000110713 | ENSG00000073614 |
| ENSG00000110713 | ENSG00000078399 |
| ENSG00000110713 | ENSG00000106031 |
| ENSG00000110713 | ENSG00000116132 |
| ENSG00000110713 | ENSG00000119335 |
| ENSG00000110713 | ENSG00000123364 |
| ENSG00000110713 | ENSG00000123388 |
| ENSG00000110713 | ENSG00000128713 |
| ENSG00000110713 | ENSG00000128714 |
| ENSG00000110713 | ENSG00000138698 |
| ENSG00000110713 | ENSG00000147548 |
| ENSG00000110713 | ENSG00000148700 |
| ENSG00000110713 | ENSG00000164985 |
| ENSG00000110713 | ENSG00000165671 |
| ENSG00000110713 | ENSG00000167157 |
| ENSG00000110713 | ENSG00000178105 |
| ENSG00000110713 | ENSG00000198900 |
| ENSG00000110777 | ENSG00000113916 |
| ENSG00000110987 | ENSG00000136997 |
| ENSG00000111640 | ENSG00000113916 |
| ENSG00000111790 | ENSG00000077782 |
| ENSG00000112081 | ENSG00000113916 |
| ENSG00000112486 | ENSG00000077782 |
| ENSG00000112701 | ENSG00000188580 |
| ENSG00000113263 | ENSG00000165025 |
| ENSG00000113594 | ENSG00000181690 |
| ENSG00000114354 | ENSG00000119508 |
| ENSG00000114354 | ENSG00000171094 |
| ENSG00000114354 | ENSG00000198400 |
| ENSG00000114999 | ENSG00000139083 |
| ENSG00000116560 | ENSG00000068323 |
| ENSG00000116604 | ENSG00000071626 |
| ENSG00000117000 | ENSG00000116990 |
| ENSG00000118058 | ENSG00000002834 |
| ENSG00000118058 | ENSG00000005339 |
| ENSG00000118058 | ENSG00000007237 |
| ENSG00000118058 | ENSG00000008300 |
| ENSG00000118058 | ENSG00000072364 |
| ENSG00000118058 | ENSG00000073921 |
| ENSG00000118058 | ENSG00000075539 |
| ENSG00000118058 | ENSG00000078403 |
| ENSG00000118058 | ENSG00000079102 |
| ENSG00000118058 | ENSG00000085832 |
| ENSG00000118058 | ENSG00000100393 |
| ENSG00000118058 | ENSG00000101367 |
| ENSG00000118058 | ENSG00000105656 |
| ENSG00000118058 | ENSG00000108292 |
| ENSG00000118058 | ENSG00000110395 |
| ENSG00000118058 | ENSG00000112305 |
| ENSG00000118058 | ENSG00000118058 |
| ENSG00000118058 | ENSG00000118689 |
| ENSG00000118058 | ENSG00000125354 |
| ENSG00000118058 | ENSG00000130382 |
| ENSG00000118058 | ENSG00000130396 |
| ENSG00000118058 | ENSG00000131759 |
| ENSG00000118058 | ENSG00000132142 |
| ENSG00000118058 | ENSG00000132394 |
| ENSG00000118058 | ENSG00000136754 |
| ENSG00000118058 | ENSG00000136848 |
| ENSG00000118058 | ENSG00000137812 |
| ENSG00000118058 | ENSG00000138336 |
| ENSG00000118058 | ENSG00000138758 |
| ENSG00000118058 | ENSG00000141985 |
| ENSG00000118058 | ENSG00000142347 |
| ENSG00000118058 | ENSG00000143443 |
| ENSG00000118058 | ENSG00000144218 |
| ENSG00000118058 | ENSG00000145012 |
| ENSG00000118058 | ENSG00000145819 |
| ENSG00000118058 | ENSG00000150455 |
| ENSG00000118058 | ENSG00000154556 |
| ENSG00000118058 | ENSG00000163655 |
| ENSG00000118058 | ENSG00000166140 |
| ENSG00000118058 | ENSG00000168385 |
| ENSG00000118058 | ENSG00000171723 |
| ENSG00000118058 | ENSG00000171843 |
| ENSG00000118058 | ENSG00000172409 |
| ENSG00000118058 | ENSG00000172493 |
| ENSG00000118058 | ENSG00000184384 |
| ENSG00000118058 | ENSG00000184481 |
| ENSG00000118058 | ENSG00000184640 |
| ENSG00000118058 | ENSG00000184702 |
| ENSG00000118058 | ENSG00000187239 |
| ENSG00000118058 | ENSG00000196914 |
| ENSG00000119397 | ENSG00000077782 |
| ENSG00000120616 | ENSG00000112511 |
| ENSG00000121741 | ENSG00000077782 |
| ENSG00000122025 | ENSG00000139083 |
| ENSG00000122566 | ENSG00000006468 |
| ENSG00000122779 | ENSG00000077782 |
| ENSG00000122779 | ENSG00000131759 |
| ENSG00000124243 | ENSG00000141376 |
| ENSG00000125618 | ENSG00000132170 |
| ENSG00000126777 | ENSG00000165731 |
| ENSG00000126883 | ENSG00000097007 |
| ENSG00000126883 | ENSG00000119335 |
| ENSG00000126883 | ENSG00000124795 |
| ENSG00000127083 | ENSG00000129204 |
| ENSG00000127152 | ENSG00000164438 |
| ENSG00000127152 | ENSG00000211829 |
| ENSG00000127914 | ENSG00000157764 |
| ENSG00000127946 | ENSG00000113721 |
| ENSG00000128487 | ENSG00000113721 |
| ENSG00000133639 | ENSG00000136997 |
| ENSG00000135903 | ENSG00000084676 |
| ENSG00000135903 | ENSG00000150907 |
| ENSG00000136167 | ENSG00000113916 |
| ENSG00000136997 | ENSG00000110987 |
| ENSG00000136997 | ENSG00000133639 |
| ENSG00000137193 | ENSG00000113916 |
| ENSG00000137309 | ENSG00000112769 |
| ENSG00000137497 | ENSG00000131759 |
| ENSG00000137727 | ENSG00000165288 |
| ENSG00000138293 | ENSG00000165731 |
| ENSG00000138363 | ENSG00000171094 |
| ENSG00000138594 | ENSG00000101977 |
| ENSG00000138674 | ENSG00000171094 |
| ENSG00000139083 | ENSG00000068078 |
| ENSG00000139083 | ENSG00000085276 |
| ENSG00000139083 | ENSG00000096968 |
| ENSG00000139083 | ENSG00000097007 |
| ENSG00000139083 | ENSG00000111816 |
| ENSG00000139083 | ENSG00000113721 |
| ENSG00000139083 | ENSG00000114999 |
| ENSG00000139083 | ENSG00000122025 |
| ENSG00000139083 | ENSG00000130675 |
| ENSG00000139083 | ENSG00000140538 |
| ENSG00000139083 | ENSG00000143322 |
| ENSG00000139083 | ENSG00000143437 |
| ENSG00000139083 | ENSG00000153233 |
| ENSG00000139083 | ENSG00000159216 |
| ENSG00000139083 | ENSG00000164398 |
| ENSG00000139083 | ENSG00000165025 |
| ENSG00000139083 | ENSG00000165556 |
| ENSG00000139083 | ENSG00000169184 |
| ENSG00000139083 | ENSG00000179094 |
| ENSG00000139083 | ENSG00000188580 |
| ENSG00000139083 | ENSG00000197880 |
| ENSG00000140262 | ENSG00000119508 |
| ENSG00000140262 | ENSG00000135605 |
| ENSG00000140464 | ENSG00000131759 |
| ENSG00000140937 | ENSG00000129204 |
| ENSG00000141367 | ENSG00000068323 |
| ENSG00000141367 | ENSG00000171094 |
| ENSG00000141380 | ENSG00000126752 |
| ENSG00000141380 | ENSG00000187754 |
| ENSG00000141380 | ENSG00000204645 |
| ENSG00000141867 | ENSG00000184507 |
| ENSG00000142611 | ENSG00000085276 |
| ENSG00000143294 | ENSG00000068323 |
| ENSG00000143549 | ENSG00000113721 |
| ENSG00000143549 | ENSG00000171094 |
| ENSG00000143549 | ENSG00000198400 |
| ENSG00000143924 | ENSG00000171094 |
| ENSG00000145216 | ENSG00000134853 |
| ENSG00000147065 | ENSG00000171094 |
| ENSG00000147140 | ENSG00000068323 |
| ENSG00000147889 | ENSG00000147889 |
| ENSG00000149948 | ENSG00000100814 |
| ENSG00000149948 | ENSG00000144476 |
| ENSG00000149948 | ENSG00000145012 |
| ENSG00000149948 | ENSG00000164919 |
| ENSG00000149948 | ENSG00000182185 |
| ENSG00000149948 | ENSG00000183722 |
| ENSG00000149948 | ENSG00000189283 |
| ENSG00000153201 | ENSG00000171094 |
| ENSG00000153814 | ENSG00000112511 |
| ENSG00000153814 | ENSG00000178691 |
| ENSG00000153944 | ENSG00000078399 |
| ENSG00000156650 | ENSG00000005339 |
| ENSG00000156976 | ENSG00000113916 |
| ENSG00000158715 | ENSG00000006468 |
| ENSG00000158715 | ENSG00000171656 |
| ENSG00000159216 | ENSG00000022556 |
| ENSG00000159216 | ENSG00000079102 |
| ENSG00000159216 | ENSG00000085276 |
| ENSG00000159216 | ENSG00000106346 |
| ENSG00000159216 | ENSG00000109686 |
| ENSG00000159216 | ENSG00000116251 |
| ENSG00000159216 | ENSG00000129993 |
| ENSG00000159216 | ENSG00000143373 |
| ENSG00000159216 | ENSG00000155313 |
| ENSG00000159216 | ENSG00000169946 |
| ENSG00000159216 | ENSG00000198492 |
| ENSG00000159216 | ENSG00000206115 |
| ENSG00000162367 | ENSG00000123473 |
| ENSG00000162775 | ENSG00000196588 |
| ENSG00000163902 | ENSG00000085276 |
| ENSG00000164692 | ENSG00000181690 |
| ENSG00000165288 | ENSG00000137727 |
| ENSG00000167460 | ENSG00000171094 |
| ENSG00000168036 | ENSG00000181690 |
| ENSG00000168421 | ENSG00000113916 |
| ENSG00000169306 | ENSG00000198947 |
| ENSG00000169696 | ENSG00000068323 |
| ENSG00000169714 | ENSG00000129204 |
| ENSG00000170791 | ENSG00000181690 |
| ENSG00000170881 | ENSG00000189283 |
| ENSG00000170961 | ENSG00000181690 |
| ENSG00000172660 | ENSG00000119508 |
| ENSG00000172660 | ENSG00000126746 |
| ENSG00000172660 | ENSG00000128656 |
| ENSG00000172660 | ENSG00000135605 |
| ENSG00000173757 | ENSG00000131759 |
| ENSG00000178104 | ENSG00000113721 |
| ENSG00000179362 | ENSG00000006468 |
| ENSG00000179583 | ENSG00000113916 |
| ENSG00000180843 | ENSG00000171094 |
| ENSG00000181163 | ENSG00000131759 |
| ENSG00000181163 | ENSG00000171094 |
| ENSG00000181163 | ENSG00000178053 |
| ENSG00000182158 | ENSG00000132170 |
| ENSG00000182944 | ENSG00000006468 |
| ENSG00000182944 | ENSG00000100105 |
| ENSG00000182944 | ENSG00000118260 |
| ENSG00000182944 | ENSG00000119508 |
| ENSG00000182944 | ENSG00000123268 |
| ENSG00000182944 | ENSG00000126746 |
| ENSG00000182944 | ENSG00000135605 |
| ENSG00000182944 | ENSG00000151702 |
| ENSG00000182944 | ENSG00000157554 |
| ENSG00000182944 | ENSG00000163497 |
| ENSG00000182944 | ENSG00000166986 |
| ENSG00000182944 | ENSG00000175197 |
| ENSG00000182944 | ENSG00000175832 |
| ENSG00000182944 | ENSG00000184937 |
| ENSG00000182944 | ENSG00000204531 |
| ENSG00000184012 | ENSG00000006468 |
| ENSG00000184012 | ENSG00000157554 |
| ENSG00000184012 | ENSG00000171656 |
| ENSG00000184012 | ENSG00000175832 |
| ENSG00000184402 | ENSG00000126752 |
| ENSG00000184507 | ENSG00000141867 |
| ENSG00000185811 | ENSG00000113916 |
| ENSG00000186716 | ENSG00000077782 |
| ENSG00000186716 | ENSG00000096968 |
| ENSG00000186716 | ENSG00000097007 |
| ENSG00000186716 | ENSG00000134853 |
| ENSG00000187735 | ENSG00000181690 |
| ENSG00000188580 | ENSG00000139083 |
| ENSG00000189283 | ENSG00000149948 |
| ENSG00000189283 | ENSG00000170881 |
| ENSG00000196092 | ENSG00000139083 |
| ENSG00000196531 | ENSG00000113916 |
| ENSG00000196535 | ENSG00000077782 |
| ENSG00000197323 | ENSG00000165731 |
| ENSG00000197711 | ENSG00000048544 |
| ENSG00000198339 | ENSG00000113916 |
| ENSG00000204691 | ENSG00000112561 |

wherein Gene A is the upstream fusion gene partner of the fusion gene and Gene B is the downstream fusion gene partner of the fusion gene.

A chimeric probe as used herein is a nucleic acid or a nucleic acid analogue, capable of sequence-specific base pairing, which comprises a first sequence corresponding to an exon of a first gene and a second sequence corresponding to an exon of a second gene. Importantly, the first gene is different from the second gene, i.e. the probe covers an intergenic exon-to-exon junction. The term exon-to-exon junction, as used in the present context, refers to an intergenic exon-to-exon junction. The chimeric probe may consist of or comprise non-natural nucleotides such as LNA monomers (locked nucleic acid monomers), INA monomers (intercalating nucleic acid monomers), or PNA monomers (peptide nucleic acid monomers).

The term fusion gene as used herein refers to the result of a genomic aberration, such as a chromosomal translocation, deletion, or inversion, bringing sequences from two different genes together. That is, the fusion gene comprises at least one exon of an upstream gene partner of the fusion gene and at least one exon of a downstream gene partner of the fusion gene.

Herein, the term fusion gene also refers to a hypothetical fusion gene that has not been experimentally verified.

For example Hahn et al, 2004 describes a bioinformatics strategy for identification of such potential fusion genes. It is envisaged that the fusion gene which is detected by the present invention may be a candidate fusion gene identified by use of the method described in Hahn et al, 2004 or other methods capable of identifying potential fusion genes.

A fusion gene partner as used herein refers to a gene that donates at least one exon to a fusion gene. The exon(s) of an upstream fusion gene partner are placed upstream of the exon(s) of the other fusion gene partner in the fusion gene transcript, and vice versa.

Of particular interest for the present invention are fusion gene partners and fusion genes that have previously been implicated in cancer. Table 1 lists preferred fusion genes with Gene A being the upstream fusion gene partner of the fusion gene and Gene B being the downstream fusion gene partner of the fusion gene.

The vast majority of fusion gene partners are fused within intron regions to create the fusion gene (Novo et al., 2007), and splicing of the pre-mRNA fusion transcript will connect exons creating an intergenic exon-to-exon junction in the fusion transcript.

Hypothetical intergenic exon-to-exon junctions can be predicted when the exon-intron structures of two fusion gene partners of a hypothetical fusion gene are known. Exons of the potential fusion gene partners can be retrieved from various internet-based genome databases, such as www.biomart.orq.

In a preferred embodiment, the microarray of the invention comprises a chimeric probe for at least 20% of all possible exon-to-exon junctions of a fusion gene.

In another preferred embodiment, the microarray of the invention comprises a chimeric probe for at least 30% of all possible exon-to-exon junctions, such as at least 40%, at least 50%, at least 60%, at least 70%, at least 80%, or at least 90%.

In yet another embodiment, the microarray of the invention comprises chimeric probes for at least 20 exon-to-exon junctions of the same or different fusion genes.

In still another preferred embodiment, the microarray comprises chimeric probes for at least 30 exon-to-exon junctions, at least 40 exon-to-exon junctions, at least 50 exon-to-exon junctions, at least 60 exon-to-exon junctions, at least 70 exon-to-exon junctions, at least 80 exon-to-exon junctions, such as at least 100 exon-to-exon junctions of the same or different fusion genes.

The present inventors have recognized that it may not be sufficient to test for previously characterized (experimentally verified) fusion genes with a pre-determined exon-to-exon junction and that it is desirable to test all possible exon-to-exon junctions of a particular fusion gene. Very often, the exact location of the exon-to-exon junction is not the decisive factor in determining whether a fusion gene is oncogenic or otherwise involved in or predictive of cancer or other conditions.

For example, for the TMPRSS2-ERG fusion gene, newly identified in prostate cancer (Tomlins et al., 2005), fusion transcripts have already been determined with junctions after exons 1, 2, 3, 4, and 5 in TMPRSS2, and before exons 2, 3, 4, 5, and 6 in ERG, at many different combinations (Clark et al., 2006). Thus, choosing the one or few junctions that are most prevalent, would give a considerable probability of false negative results. This particular fusion gene is also an example of a fusion gene being created by deletion of a relatively small chromosomal fragment (3 Mbp), subsequently joining the two fusion gene partners. This small aberration is invisible by cytogenetic analyses due to the resolution level.

Oncogenicity may simply lie in overexpression of the downstream part of the fusion gene. Therefore, one advantage of the present invention is that it does not rely on a single or few pre-determined exon-to-exon junctions, but it is capable of detecting all possible exon-to-exon junctions of a given fusion gene.

Another advantage is that the invention does not require fresh cells as do e.g. karyotyping, described in the background section. Moreover, interpreting the results of the microarray analysis is more straightforward than interpreting the result of karyotyping, which takes highly trained personnel. In principle, the set of intergenic exon-to-exon junction probes on the microarray will only produce a significant signal at a spot corresponding to an exon-to-exon junctions present in a fusion gene transcript.

Further, in contrast to a cytogenetic approach, there is no risk for selection among cells with the current invention, because RNA from all the cells of the biological sample is included into the measurements.

In a preferred embodiment, the microarray of the invention comprises a chimeric probe for each possible exon-to-exon junction of the fusion gene.

Preferably, the microarray of the invention comprises chimeric probes for more than one fusion gene. For example the microarray of the present invention may comprise chimeric probes for at least 2 fusion genes, such as at least 5 fusion genes or at least 10 fusion genes, or at least 20 fusion genes, or at least 30 fusion genes, or at least 50 fusion genes, or at least 75 fusion genes, or at least 100 fusion genes, or at least 250 fusion genes or at least 500 fusion genes, or at least 1000 fusion genes. Thus, in a preferred embodiment, the microarray of the invention comprises chimeric probes for a number of fusion genes listed in Table 1, selected from the group consisting of at least 5 fusion genes, at least 10 fusion genes, at least 20 fusion genes, at least 30 fusion genes, at least 40 fusion genes, at least 50 fusion genes, at least 75 fusion genes, at least 100 fusion genes, at least 150 fusion genes, at least 200 fusion genes, at least 250 fusion genes, at least 275 fusion genes and at least 316 fusion genes.

In an even more preferred embodiment, the microarray of the invention comprises chimeric probes for each possible intergenic exon-to-exon junction for a number of fusion genes listed in Table 1, selected from the group consisting of at least 5 fusion genes, at least 10 fusion genes, at least 20 fusion genes, at least 30 fusion genes, at least 40 fusion genes, at least 50 fusion genes, at least 75 fusion genes, at least 100 fusion genes, at least 150 fusion genes, at least 200 fusion genes, at least 250 fusion genes, at least 275 fusion genes and at least 316 fusion genes.

Most preferably, the microarray of the invention comprises chimeric probes for each possible intergenic exon-to-exon junction for all fusion genes listed in Table 1. Even more preferably, the microarray of the present invention comprises a chimeric probe and at least two intragenic probes for all fusion genes listed in Table 1. Such a microarray is useful for identification of fusion genes in any sample and requires no prior knowledge of pre-dispositions to particular fusion genes based on e.g. cancer type or patient history.

The sequence of the chimeric probes of the microarray comprise a first part and a second part, wherein the first part corresponds to the 3′ end of an exon sequence of an upstream fusion gene partner and a second part corresponds to the 5′ end of an exon sequence of a downstream fusion gene partner, wherein said chimeric probes are either antisense probes oriented to hybridise to mRNA or double-stranded cDNA, or sense probes being oriented to hybridise to cDNA of the fusion genes. Thus, the term “corresponds” as used in this context refers to either the same sequence or the complementary sequence.

The microarray may comprise both antisense and sense probes for each exon-to-exon junction, i.e. it may be useful for hybridisation with both cDNA and mRNA or both strands of a PCR product.

Preferably, the chimeric probes are isothermic, i.e. they are adjusted in length to have melting temperatures (Tm value) that differs by at most 20 degrees Celsius when hybridised to a complementary DNA sequence under the conditions employed for hybridisation of the microarray. In other embodiments, the Tm values differ by at most 40 degrees Celsius 35 degrees, Celsius 30 degrees Celsius, 25 degrees Celsius, 15 degrees Celsius, and 10 degrees Celsius, respectively. Isothermic probes are favourable to enable good hybridisation conditions across the complete set of probes on the microarray.

Moreover, the first part and the second part of the chimeric probes are preferably adjusted in length to have Tm values that differs at most 10 degree Celsius under the conditions employed for hybridisation of the microarray. In other embodiments, the Tm values differ by at most 16 degrees Celsius, 14 degrees Celsius, 12 degrees Celsius, 8 degrees Celsius, 6 degrees and 4 degrees Celsius.

Adjustment of the Tm value of a probe or part of a probe may be achieved because the Tm value is dependent on the length and percentage of guanines and cytosines in the nucleotide sequence of the probe or part of the probe. It may be decided that the chimeric probes should have a Tm-value of e.g. about 68 degrees Celsius. As a start, the Tm value of a chimeric probe of 10 nucleotides for the first and the second part may be used. If the Tm value for this probe is below 68 degrees Celsius, nucleotides may be added in a balanced manner to both the first and the second part until the overall Tm value of the chimeric probe is about 68 degrees Celsius. Thus, if the first part comprises more A, T, or U nucleotides than the second part, more nucleotides will have to be added to the first part. The procedure is performed using an oligo design algorithm.

In a preferred embodiment of the invention, the Tm of the chimeric probes are above the temperature used for hybridisation and the Tm of upstream or/and downstream parts of the chimeric probes is below the temperature used for hybridisation.

The Tm value of the chimeric probe is preferably selected from the group consisting of more than 45 degrees Celsius, more than 50 degrees Celsius, more than 55 degrees Celsius, more than 60 degrees Celsius, more than 65 degrees Celsius, more than 70 degrees Celsius and more than 75 degrees Celsius.

The length of the chimeric probe is preferably selected from the group consisting of less than 60 nucleotides, less than 55 nucleotides, less than 50 nucleotides, less than 45 nucleotides, less than 40 nucleotides and less than 35 nucleotides.

In another preferred embodiment, the microarray further comprises chimeric probes targeting single nucleotide polymorphic (SNP) variants of exon-to-exon junctions. Such SNPs can be retrieved from a genome database (such as www.biomart.org) for all fusion gene partners of table 1. Where SNPs are located within a sequence flanking an exon-to-exon junction, chimeric probes including each of the SNP variants are constructed. By including the polymorphic variants of exon-to-exon junctions, it is ensured that fusion genes are not missed due to mismatches between nucleotide sequences of chimeric probes and exon-to-exon junctions.

The microarray of the invention may be purchased from several manufacturers, e.g. Agilent, Illumina, and Nimblegen. Positive signals on the microarray are typically detected by measuring fluorescence or chemiluminescence, obtained from directly or indirectly labelled nucleotides of the mRNA or cDNA from the sample.

Methods of preparing probes or oligos and methods of applying such probes to a microarray are well known to a person skilled in the art.

The scoring of the exon-to-exon junction probes is relatively straightforward. This is because the majority of the thousands of spots will be negative, and only the features with positive exon-to-exon junction probes produce a significant positive signal. Existence of a fusion gene, creating a positive signal from a chimeric probe, may be supported by corresponding shifts in the normalized longitudinal expression level profiles created by the intragenic probes of the two fusion gene partners.

To facilitate the data analysis for samples, especially for samples with unknown presence of fusion gene(s), a “fusion score” can be calculated for each possible intronic fusion breakpoint and they indicate the probability of a fusion event. Two such fusion scores can be calculated for each chimeric junction probe. These combine values from the chimeric probes with values obtained with the intragenic probes, i.e. the longitudinal profiles of either the upstream or the downstream fusion gene partner respectively. Said fusion scores are calculated using the following equation:

[Fusion score=Chimeric junction score*P(transcript-wise)*P(exon-wise)]

where the chimeric junction score is a normalised value for the chimeric probe signal, the P(transcript-wise) is the probability that the exonic expression values of the fusion gene partners are from separate populations before and after the anticipated fusion breakpoint, and the P(exon-wise) is the probability that the exonic expression values of the immediate upstream and downstream exons of the fusion gene partner are from separate populations. The term “separate populations” refers in this context to the same gene but where the gene has been fused to another gene thereby creating changes in the expression level of the individual exons of said gene.

The p(transcript-wise) and p(exon-wise) are calculated based on t-tests comparing the intragenic expression values from upstream and downstream of the possible fusion breakpoint, testing whether the longitudinal profile has a breakpoint at the given position.

The calculation of a fusion score provides an easy way to interpret the value for the probability of a fusion event at a given exon-exon junction, thereby enabling analysis and interpretation of the results by non-experts. To keep the values within scale, the following thresholds may be applied. When the normalised values for chimeric probes are larger than 10, these may be set to 10. Similarly, when probabilities for a breakpoint in the longitudinal profiles are <0.10, these values may be set to 0.10. When the values from the downstream fusion gene partner exons were lower than the values from the upstream fusion gene partner exons, the probability may also be set to 0.10.

A second aspect of the invention is a method of detecting a fusion gene comprising the steps of
a. Providing a sample
b. Isolating RNA from the sample
c. Detecting exon-to-exon junctions of mRNAs from the sample using the microarray of the invention
d. Thereby identifying fusion genes present in the sample

In one embodiment of the present invention the method may further comprise the step of detecting the expression level of a fusion gene partner of the fusion gene using the microarray of the invention. Typically this may be performed in step c) of the above mentioned method; i.e. when the exon-to-exon junctions of the mRNA from the sample using the microarray of the invention are detected.

Thus in particular embodiment step c) may be:

c. Detecting exon-to-exon junctions of mRNAs from the sample using a microarray comprising a chimeric probe for an intergenic exon-to-exon junction of a fusion gene and a microarray comprising at least two intragenic probes for a fusion gene partner of said fusion gene.

In a further embodiment of step c) the chimeric probe and the at least two intragenic probes may be present on individual microarrays or they may be present on the same microarray.

The method of the present invention may further comprise the step of comparing the exon-to-exon junction(s) of the fusion gene detected by the chimeric probes with the exon-to-exon junction(s) detected with the intragenic probes using the microarray of the present invention.

In step c) of the method of the present invention when images from the microarray are measured, positive fusion genes may be scored by observing the following:

1. Strong intensity for a chimeric fusion gene probe is indicative of the presence of that particular fusion gene, with that particular chimeric exon-to-exon junction in the fusion transcript.

2. Additionally, from the intragenic probes we may see a difference in the normalized general gene expression levels between up- and downstream parts of the transcripts for one or both of the two fusion gene partners. Typically, there may be intragenic probes (also called longitudinal probes or oligos) for each of the included fusion gene partners which may e.g. include three intra-exon probes (oligos) per exon, and exon-to-exon junction probes (oligos). Typically, as one move from the 5′ to the 3′ end of these transcripts, a drop in the expression levels in the upstream fusion gene partner (Gene A), and an increase in the signals for the downstream fusion gene partner (Gene B) may be seen. These shifts in normalized expression levels should occur at intragenic positions that correspond to the positive intergenic/chimeric junction probe (oligo) as described in point 1.

3. Furthermore, a “fusion score” can be calculated for each chimeric junction probe as described above. The fusion score combines the scores of the chimeric fusion gene probe and the intragenic probes. This fusion score provides an easy way to express the likelihood of having a particular exon-exon junction in the fusion gene transcript.

For an RNA sample with a fusion transcript, a combination of 1 and 2 above may be seen (as illustrated in FIGS. 1 to 3). However, combining 1 and 3, 2 and 3 or 1, 2 and 3 is also anticipated by the present invention.

The method may comprise preparation of cDNA from the RNA in step b) using either oligo-dT priming or random primers, such as hexamers. In this embodiment, the exon-to-exon junction is detected on the cDNA level.

The method of the present invention may also comprise labelling of the sample. Methods of labelling mRNA or cDNA are known to a person skilled in the art and include labelling of the cDNA by inclusion of e.g. Cy3 and/or Cy5-modified dNTP's as described in example 2.

Typically detection of exon-exon junctions in step c) of the method is obtained by hybridising the mRNA or cDNA obtained from the sample to the microarray. Methods of hybridising mRNA or cDNA to microarrays are well known to a person skilled in the art.

The sample may be any biological material, such as e.g. blood or bone marrow from a patient or person suspected having a cancer. Another example of a sample is tissue obtained from a solid tumour.

A particular advantage of the present invention is that it may be performed without performing RT-PCR on the RNA or PCR on cDNA obtained in step b) prior to detection of the fusion gene with a microarray.

A third aspect of the invention is a kit comprising the microarray of the invention and random primers for cDNA synthesis and/or oligo-dT primers for cDNA synthesis. Preferably, the kit further comprises a reverse transcriptase and reagents necessary for cDNA synthesis.

In a particular embodiment the kit comprises a microarray comprising a chimeric probe for an intergenic exon-to-exon junction of a fusion gene, a microarray comprising at least two intragenic probes for a fusion gene partner and random primers for cDNA synthesis and/or oligo-dT primers for cDNA synthesis.

The chimeric probe and the at least two intragenic probes of the kit may be present on individual microarrays or they may be present on the same microarray.

### EXAMPLES

### Example 1

### Creation of Junction Probes (Oligos) and Microarray

For generation of the junction probes (oligos), we created a computer script (written in the programming language Python) that automatically processes public genome data. For all genes, and all their transcripts, the exon sequences were retrieved. We used the www.biomart.org internet portal. For each fusion gene combination, end sequences (the last 30 nucleotides) of all GeneA exons and start-sequences (30 nt) of all GeneB exons were joined at all combinations. Next, an oligo design algorithm was used to create probes (oligos) from each of these possible fusion gene exon-to-exon junctions. We have here used Tm optimally at 68 Celsius, and with equalized Tm from each side of the junction. In our example, we have generated exon-to-exon junction probes (oligos) ranging 33 to 46 nucleotides in length.

In this way, 47427 junction probes (oligos) were designed for 275 fusion genes.

To increase the sensitivity and specificity, intragenic probes (longitudinal oligos) were also designed. These are sets of probes (oligos) measuring expression levels along the transcripts for the individual fusion gene partners. Three probes (oligos) were generated targeting internally to each exon sequence, at the start, mid, and end, and probes (oligos) were also generated targeting the intragenic exon-to-exon junctions. Exon-to-intron junctions and intron-to-exon junctions were also included as the pre-mRNA processing machinery may alter the splicing pattern following removal or introduction of cis-acting splicing regulatory sequences.

To reduce “half-binder” effects of the probes, the probes (oligos) used in our prototype were rather short in length (34-40mers), and we constructed them with equal melting temperatures on each side of the junctions. Because of the short sequences on each side of the junction, the binding may be sensitive to single nucleotide polymorphisms (SNPs). Thus, at known SNP-positions, we created extra sets of probes, accounting for each of the SNP variants. We also generated a second version of the array with longer probes (oligos) (44-55mers).

The described microarray was generated, including chimeric probes (oligos) targeting all possible junction sequences of 275 known fusion genes, and also intragenic probes (longitudinal oligos) for 100 of the genes. For seven fusion genes, including the ones included as positive control fusion genes, the chimeric probes (oligos) were included in quadruplicates. All of their belonging fusion gene partners were also among the list of 100 genes for which intragenic probes (oligos) were created. Overall, the pilot fusion gene microarray included a design with 69729 probes (oligos) which were synthesised onto Nimblegen microarray slides, which currently can contain 2.1 million different oligo sequences per microarray.

### Example 2

### The Microarray in Action

In a proof-of-principle experiment, we analysed a set of positive control samples, with known presence of one fusion gene each. The pilot samples included four prostate cancer tissue samples positive for the TMPRSS2:ERG fusion gene, and two leukaemia cell lines, each known to carry one of the TCF3:PBX1 and ETV6:RUNX1 fusion genes.

For the pilot samples, total RNA was isolated by use of Qiagen spin columns. Further, they were enriched for mRNA by a ribosomal RNA reduction kit (RiboMinus™ Transcriptome Isolation Kit; Invitrogen). From these, first strand cDNA synthesis was performed with use of random primers (hexamers), and double stranded cDNA was made and shipped to Nimblegen Inc. for labelling, hybridisation, washing, and scanning of microarrays. The cDNA was labelled by inclusion of Cy3 and Cy5-modified dNTPs.

Results

To visualize the measurements for the positive control genes, we followed two independent paths, using either of the chimeric probe set, or the intragenic (longitudinal) probe set. All six samples had clear patterns of fusion genes, and thus validating the concept.

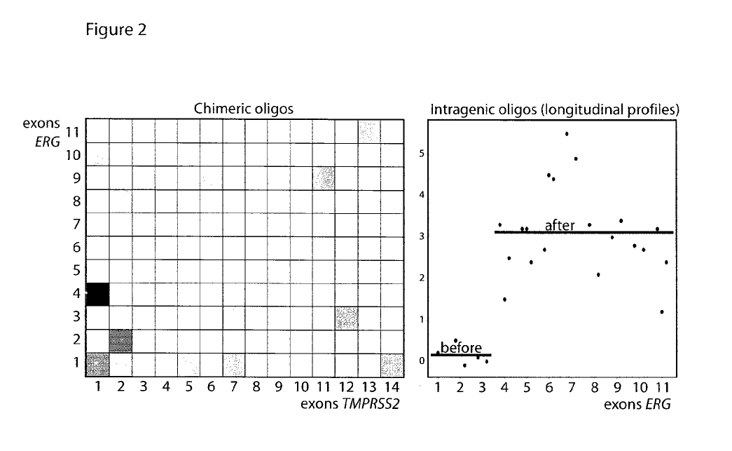

To evaluate the variability of a given fusion gene, we used the TMPRSS2:ERG fusion gene in prostate cancer as a model. Here, we analyzed malignant prostate tissue samples from four individual tumours. FIG. 2 shows the results obtained from one of these samples. The leftmost picture in FIG. 2 shows the results obtained from hybridisation with the chimeric exon-to-exon probes. The individual exons of the TMPRSS2 and the ERG genes are depicted along the X- and Y-axis, respectively and the amount of sample hybridised to the chimeric exon-to-exon probes are visualized by the shading density. From this picture it can be seen that there is a strong density from the chimeric probes corresponding to TMPRSS2 exon 1 and ERG exon 4. This indicates existence of a TMPRSS2:ERG fusion gene which is fused between TMPRSS2 exon 1 and ERG exon 4 in the sample material. The rightmost graph in FIG. 2 shows the expression level of the individual exons of the ERG gene as detected with the intragenic ERG probes. As seen from this graph the average expression level of exons 1-3 is lower than that of exons 4-11 indicating that the ERG gene is expressed as a fusion gene and that only exons 4-11 of the gene are included in the fusion transcript. Hence, the results obtained with the chimeric and intragenic probes are in concordance, and in combination they provide strong evidence that the prostate cancer sample comprises a TMPRSS2:ERG gene where the fusion junction is between exon 1 of TMPRSS2 and exon 4 of ERG. By cDNA sequencing, we have also confirmed this exact fusion junction at the nucleotide level (data not shown).

As seen in FIG. 2 the results obtained with the chimeric probes shows also, although weaker, signal intensities at other spots than the spot from TMPRSS2 exon 1 and ERG exon 4. These are e.g. those from TMPRSS2 exon 1 to ERG exon 1, and from TMPRSS2 exon 2 to ERG exon 2. However, we see that these candidate fusion junctions are not reflected by the longitudinal profile of ERG. Thus, this illustrates how inclusion of intragenic probes (oligos) reduces the likelihood of scoring false positives.

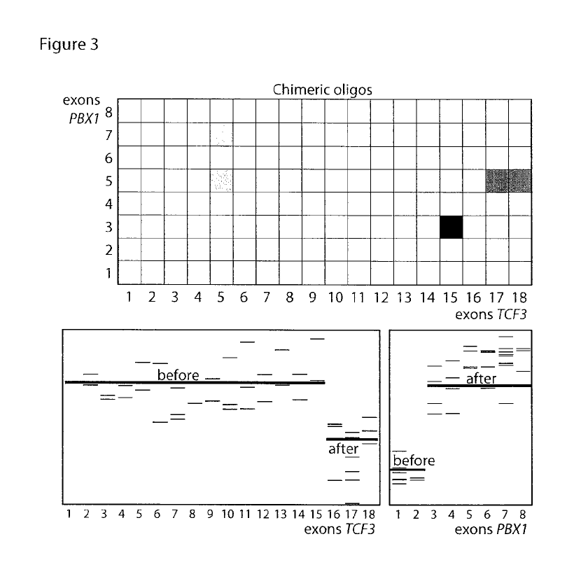

FIG. 3 shows the results that were obtained and the data are similar to those described with regard to FIG. 2. The results obtained with the chimeric probes are shown in the top picture while the results obtained with the intragenic probes towards the exons of TCF3 and PBX1 are shown in the left and right bottom graphs of the figure. By plotting their intensities according to exon numbers of the up- or downstream fusion gene partner (left and right bottom graph), we see the same picture as obtained with the chimeric exon-to-exon probes (top picture). The longitudinal profiles (obtained with the intragenic probes) support on the existence of the same fusion break points as detected with the chimeric probes; i.e. that the TCF3:PBX1 fusion gene in this cell line contains exons 1-15 of TCF3 fused to exons 4-8 of PBX1. Furthermore, cDNA sequencing from this cell line validated that the fusion transcript break point determined by the fusion gene microarray was correct down to the single nucleotide level.

RUNX1 is one of the most frequent targets of chromosomal rearrangements in human leukaemia. To date, 21 types of translocations involving RUNX1 have been reported, and 12 partner genes have been cloned and identified (14). One of the samples analyzed here, the REH cell line, carried an ETV6:RUNX1 fusion gene. This was detected similarly as described above for the TMPRSS2:ERG and TCF3:PBX1 genes by using chimeric exon-to-exon probes and intragenic probes targeting the exons of the ETV6 gene. The data showed that REH cell line contained an ETV6:RUNX1 fusion gene where the end of exon 5 of the ETV6 gene was fused to the beginning of exon 2 of the RUNX1 gene.

To determine our ability to detect fusion genes without prior knowledge of their presence or identity, we also performed unsupervised data analysis, in which the probability of a fusion event is calculated at all potential fusion gene junctions. For these analyses, a fusion score, calculated from the normalised value from the chimeric probe, is multiplied with probabilities of a fusion breakpoint at the up- or downstream fusion gene partners, as seen from their longitudinal profiles.

For each exon-exon junction at longitudinal profiles of the fusion partner genes, two probabilities are calculated. A transcript-wise probability is based on a t-test for whether values from all upstream and all downstream exons are likely to belong to separate populations. An exon-wise probability is based on a t-test for whether the values from the immediate up- and downstream exons are likely to belong to separate populations.

For each chimeric junction probe, two such fusion scores were calculated. These were combining values from the chimeric probes (oligos) with values from the longitudinal profiles of either the upstream or the downstream fusion gene partner.

[Fusion score=Chimeric junction score*P(transcript-wise)*P(exon-wise)]

For both the samples visualized in FIGS. 2 and 3, the validated fusion events had the highest fusion score among the 10297 fusion transcript possibilities that were interrogated in the pilot data.

To keep the values within scale, the following thresholds were applied. When the normalised values for chimeric probes were larger than 10, these were set to 10. Similarly, when probabilities for a breakpoint in the longitudinal profiles were <0.10, these values were set to 0.10. When the values from the downstream fusion gene partner exons were lower than the values from the upstream fusion gene partner exons, the probability was as well set to 0.10.

### REFERENCES

Bingham J, Sudarsanam S, and Srinivasan S (2006). Profiling human phosphodiesterase genes and splice isoforms. Biochem. Biophys. Res Commun., 350(1): 25-32.
Clark J, Merson S, Jhavar S, Flohr P, Edwards S, Foster C S, Eeles R, Martin F L, Phillips D H, Crundwell M, Christmas T, Thompson A, Fisher C, Kovacs G, and Cooper C S (2006). Diversity of TMPRSS2-ERG fusion transcripts in the human prostate. Oncogene, [Epub ahead of print].
Johnson J M, Castle J, Garrett-Engele P, Kan Z, Loerch P M, Armour C D, Santos R, Schadt E E, Stoughton R, and Shoemaker D D (2003). Genome-wide survey of human alternative pre-mRNA splicing with exon junction microarrays. Science, 302(5653): 2141-2144.
Mitelman F, Johansson B, and Mertens F (2007). The impact of translocations and gene fusions on cancer causation. Nat. Rev. Cancer., 7(4): 233-245.
Nasedkina T, Domer P, Zharinov V, Hoberg J, Lysov Y, and Mirzabekov A (2002). Identification of chromosomal translocations in leukemias by hybridization with oligonucleotide microarrays. Haematologica., 87(4): 363-372.
Nasedkina T V, Zharinov V S, Isaeva E A, Mityaeva O N, Yurasov R N, Surzhikov S A, Turigin A Y, Rubina A Y, Karachunskii A I, Gartenhaus R B, and Mirzabekov A D (2003). Clinical screening of gene rearrangements in childhood leukemia by using a multiplex polymerase chain reaction-microarray approach. Clin. Cancer Res., 9(15): 5620-5629.
Novo F J, de Mendibil I O, and Vizmanos J L (2007). TICdb: a collection of mapped translocation breakpoints in cancer. BMC Genomics, 8: 33.
Shi R Z, Morrissey J M, and Rowley J D (2003). Screening and quantification of multiple chromosome translocations in human leukemia. Clin. Chem., 49(7): 1066-1073.
Teixeira M R (2006). Recurrent fusion oncogenes in carcinomas. Critical Rev. Oncogen., 12(3-4): 257-271.
Tomlins S A, Rhodes D R, Perner S, Dhanasekaran S M, Mehra R, Sun X W, Varambally S, Cao X, Tchinda J, Kuefer R, Lee C, Montie J E, Shah R B, Pienta K J, Rubin M A, and Chinnaiyan A M (2005). Recurrent fusion of TMPRSS2 and ETS transcription factor genes in prostate cancer. Science, 310(5748): 644-648.
Hahn Y, Bera T K, Gehlhaus K, Kirsch I R, Pastan I H and Lee B (2004). Finding fusion genes resulting from chromosome rearrangement by analyzing the expressed sequence databases. PNAS, 101(36): 13257-13261.

1. A microarray comprising a chimeric probe for an intergenic exon-to-exon junction of a fusion gene and at least two intragenic probes for each of the included fusion gene partners of the fusion gene, wherein said at least two intragenic probes for each of the included fusion gene partners are capable of targeting each side of said fusion gene break point of said fusion gene partner, and wherein the intragenic probes are either antisense probes or sense probes.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. The microarray of claim 1, wherein the microarray comprises at least 4 intragenic probes, or at least 5 intragenic probes, or at least 6 intragenic probes, or at least 7 intragenic probes, or at least 8 intragenic probes, or at least 9 intragenic probes, or at least 10 intragenic probes, or at least 20 intragenic probes.

20. The microarray of claim 1, wherein the target of the intragenic probes is selected from the group consisting of intra-exon sequences, exon-to-exon junctions, exon-intron junctions, and intron-exon junctions of the fusion gene partner.

21. The microarray of claim 1, wherein the fusion gene is selected from the group consisting of:

| Gene A | Gene B |
|---|---|
| ENSG00000009709 | ENSG00000150907 |
| ENSG00000010404 | ENSG00000197021 |
| ENSG00000015133 | ENSG00000113721 |
| ENSG00000015133 | ENSG00000134853 |
| ENSG00000023445 | ENSG00000172175 |
| ENSG00000029725 | ENSG00000113721 |
| ENSG00000047410 | ENSG00000105976 |
| ENSG00000047410 | ENSG00000198400 |
| ENSG00000047932 | ENSG00000047936 |
| ENSG00000054118 | ENSG00000129204 |
| ENSG00000066455 | ENSG00000165731 |
| ENSG00000066629 | ENSG00000097007 |
| ENSG00000067369 | ENSG00000113721 |
| ENSG00000067955 | ENSG00000133392 |
| ENSG00000069399 | ENSG00000136997 |
| ENSG00000071564 | ENSG00000105619 |
| ENSG00000071564 | ENSG00000108924 |
| ENSG00000071564 | ENSG00000185630 |
| ENSG00000072274 | ENSG00000113916 |
| ENSG00000072864 | ENSG00000113721 |
| ENSG00000073921 | ENSG00000078403 |
| ENSG00000077150 | ENSG00000059377 |
| ENSG00000078674 | ENSG00000096968 |
| ENSG00000078674 | ENSG00000165731 |
| ENSG00000080824 | ENSG00000113916 |
| ENSG00000082805 | ENSG00000165731 |
| ENSG00000083168 | ENSG00000005339 |
| ENSG00000083168 | ENSG00000100393 |
| ENSG00000083168 | ENSG00000140396 |
| ENSG00000083168 | ENSG00000143970 |
| ENSG00000089280 | ENSG00000123268 |
| ENSG00000089280 | ENSG00000157554 |
| ENSG00000089280 | ENSG00000157613 |
| ENSG00000089280 | ENSG00000166986 |
| ENSG00000089280 | ENSG00000175197 |
| ENSG00000089280 | ENSG00000175197 |
| ENSG00000089280 | ENSG00000182158 |
| ENSG00000096384 | ENSG00000113916 |
| ENSG00000100345 | ENSG00000171094 |
| ENSG00000100503 | ENSG00000113721 |
| ENSG00000100815 | ENSG00000113721 |
| ENSG00000103522 | ENSG00000113916 |
| ENSG00000105662 | ENSG00000184384 |
| ENSG00000105810 | ENSG00000078403 |
| ENSG00000105810 | ENSG00000085276 |
| ENSG00000105810 | ENSG00000118058 |
| ENSG00000105810 | ENSG00000164438 |
| ENSG00000108091 | ENSG00000113721 |
| ENSG00000108091 | ENSG00000165731 |
| ENSG00000108821 | ENSG00000100311 |
| ENSG00000108821 | ENSG00000129204 |
| ENSG00000108946 | ENSG00000165731 |
| ENSG00000109220 | ENSG00000139083 |
| ENSG00000109471 | ENSG00000048462 |
| ENSG00000109906 | ENSG00000131759 |
| ENSG00000110092 | ENSG00000070404 |
| ENSG00000110619 | ENSG00000171094 |
| ENSG00000110713 | ENSG00000005073 |
| ENSG00000110713 | ENSG00000024862 |
| ENSG00000110713 | ENSG00000040633 |
| ENSG00000110713 | ENSG00000073614 |
| ENSG00000110713 | ENSG00000078399 |
| ENSG00000110713 | ENSG00000106031 |
| ENSG00000110713 | ENSG00000116132 |
| ENSG00000110713 | ENSG00000119335 |
| ENSG00000110713 | ENSG00000123364 |
| ENSG00000110713 | ENSG00000123388 |
| ENSG00000110713 | ENSG00000128713 |
| ENSG00000110713 | ENSG00000128714 |
| ENSG00000110713 | ENSG00000138698 |
| ENSG00000110713 | ENSG00000147548 |
| ENSG00000110713 | ENSG00000148700 |
| ENSG00000110713 | ENSG00000164985 |
| ENSG00000110713 | ENSG00000165671 |
| ENSG00000110713 | ENSG00000167157 |
| ENSG00000110713 | ENSG00000178105 |
| ENSG00000110713 | ENSG00000198900 |
| ENSG00000110777 | ENSG00000113916 |
| ENSG00000110987 | ENSG00000136997 |
| ENSG00000111640 | ENSG00000113916 |
| ENSG00000111790 | ENSG00000077782 |
| ENSG00000112081 | ENSG00000113916 |
| ENSG00000112486 | ENSG00000077782 |
| ENSG00000112701 | ENSG00000188580 |
| ENSG00000113263 | ENSG00000165025 |
| ENSG00000113594 | ENSG00000181690 |
| ENSG00000114354 | ENSG00000119508 |
| ENSG00000114354 | ENSG00000171094 |
| ENSG00000114354 | ENSG00000198400 |
| ENSG00000114999 | ENSG00000139083 |
| ENSG00000116560 | ENSG00000068323 |
| ENSG00000116604 | ENSG00000071626 |
| ENSG00000117000 | ENSG00000116990 |
| ENSG00000118058 | ENSG00000002834 |
| ENSG00000118058 | ENSG00000005339 |
| ENSG00000118058 | ENSG00000007237 |
| ENSG00000118058 | ENSG00000008300 |
| ENSG00000118058 | ENSG00000072364 |
| ENSG00000118058 | ENSG00000073921 |
| ENSG00000118058 | ENSG00000075539 |
| ENSG00000118058 | ENSG00000078403 |
| ENSG00000118058 | ENSG00000079102 |
| ENSG00000118058 | ENSG00000085832 |
| ENSG00000118058 | ENSG00000100393 |
| ENSG00000118058 | ENSG00000101367 |
| ENSG00000118058 | ENSG00000105656 |
| ENSG00000118058 | ENSG00000108292 |
| ENSG00000118058 | ENSG00000110395 |
| ENSG00000118058 | ENSG00000112305 |
| ENSG00000118058 | ENSG00000118058 |
| ENSG00000118058 | ENSG00000118689 |
| ENSG00000118058 | ENSG00000125354 |
| ENSG00000118058 | ENSG00000130382 |
| ENSG00000118058 | ENSG00000130396 |
| ENSG00000118058 | ENSG00000131759 |
| ENSG00000118058 | ENSG00000132142 |
| ENSG00000118058 | ENSG00000132394 |
| ENSG00000118058 | ENSG00000136754 |
| ENSG00000118058 | ENSG00000136848 |
| ENSG00000118058 | ENSG00000137812 |
| ENSG00000118058 | ENSG00000138336 |
| ENSG00000118058 | ENSG00000138758 |
| ENSG00000118058 | ENSG00000141985 |
| ENSG00000118058 | ENSG00000142347 |
| ENSG00000118058 | ENSG00000143443 |
| ENSG00000118058 | ENSG00000144218 |
| ENSG00000118058 | ENSG00000145012 |
| ENSG00000118058 | ENSG00000145819 |
| ENSG00000118058 | ENSG00000150455 |
| ENSG00000118058 | ENSG00000154556 |
| ENSG00000118058 | ENSG00000163655 |
| ENSG00000118058 | ENSG00000166140 |
| ENSG00000118058 | ENSG00000168385 |
| ENSG00000118058 | ENSG00000171723 |
| ENSG00000118058 | ENSG00000171843 |
| ENSG00000118058 | ENSG00000172409 |
| ENSG00000118058 | ENSG00000172493 |
| ENSG00000118058 | ENSG00000184384 |
| ENSG00000118058 | ENSG00000184481 |
| ENSG00000118058 | ENSG00000184640 |
| ENSG00000118058 | ENSG00000184702 |
| ENSG00000118058 | ENSG00000187239 |
| ENSG00000118058 | ENSG00000196914 |
| ENSG00000119397 | ENSG00000077782 |
| ENSG00000120616 | ENSG00000112511 |
| ENSG00000121741 | ENSG00000077782 |
| ENSG00000122025 | ENSG00000139083 |
| ENSG00000122566 | ENSG00000006468 |
| ENSG00000122779 | ENSG00000077782 |
| ENSG00000122779 | ENSG00000131759 |
| ENSG00000124243 | ENSG00000141376 |
| ENSG00000125618 | ENSG00000132170 |
| ENSG00000126777 | ENSG00000165731 |
| ENSG00000126883 | ENSG00000097007 |
| ENSG00000126883 | ENSG00000119335 |
| ENSG00000126883 | ENSG00000124795 |
| ENSG00000127083 | ENSG00000129204 |
| ENSG00000127152 | ENSG00000164438 |
| ENSG00000127152 | ENSG00000211829 |
| ENSG00000127914 | ENSG00000157764 |
| ENSG00000127946 | ENSG00000113721 |
| ENSG00000128487 | ENSG00000113721 |
| ENSG00000133639 | ENSG00000136997 |
| ENSG00000135903 | ENSG00000084676 |
| ENSG00000135903 | ENSG00000150907 |
| ENSG00000136167 | ENSG00000113916 |
| ENSG00000136997 | ENSG00000110987 |
| ENSG00000136997 | ENSG00000133639 |
| ENSG00000137193 | ENSG00000113916 |
| ENSG00000137309 | ENSG00000112769 |
| ENSG00000137497 | ENSG00000131759 |
| ENSG00000137727 | ENSG00000165288 |
| ENSG00000138293 | ENSG00000165731 |
| ENSG00000138363 | ENSG00000171094 |
| ENSG00000138594 | ENSG00000101977 |
| ENSG00000138674 | ENSG00000171094 |
| ENSG00000139083 | ENSG00000068078 |
| ENSG00000139083 | ENSG00000085276 |
| ENSG00000139083 | ENSG00000096968 |
| ENSG00000139083 | ENSG00000097007 |
| ENSG00000139083 | ENSG00000111816 |
| ENSG00000139083 | ENSG00000113721 |
| ENSG00000139083 | ENSG00000114999 |
| ENSG00000139083 | ENSG00000122025 |
| ENSG00000139083 | ENSG00000130675 |
| ENSG00000139083 | ENSG00000140538 |
| ENSG00000139083 | ENSG00000143322 |
| ENSG00000139083 | ENSG00000143437 |
| ENSG00000139083 | ENSG00000153233 |
| ENSG00000139083 | ENSG00000159216 |
| ENSG00000139083 | ENSG00000164398 |
| ENSG00000139083 | ENSG00000165025 |
| ENSG00000139083 | ENSG00000165556 |
| ENSG00000139083 | ENSG00000169184 |
| ENSG00000139083 | ENSG00000179094 |
| ENSG00000139083 | ENSG00000188580 |
| ENSG00000139083 | ENSG00000197880 |
| ENSG00000140262 | ENSG00000119508 |
| ENSG00000140262 | ENSG00000135605 |
| ENSG00000140464 | ENSG00000131759 |
| ENSG00000140937 | ENSG00000129204 |
| ENSG00000141367 | ENSG00000068323 |
| ENSG00000141367 | ENSG00000171094 |
| ENSG00000141380 | ENSG00000126752 |
| ENSG00000141380 | ENSG00000187754 |
| ENSG00000141380 | ENSG00000204645 |
| ENSG00000141867 | ENSG00000184507 |
| ENSG00000142611 | ENSG00000085276 |
| ENSG00000143294 | ENSG00000068323 |
| ENSG00000143549 | ENSG00000113721 |
| ENSG00000143549 | ENSG00000171094 |
| ENSG00000143549 | ENSG00000198400 |
| ENSG00000143924 | ENSG00000171094 |
| ENSG00000145216 | ENSG00000134853 |
| ENSG00000147065 | ENSG00000171094 |
| ENSG00000147140 | ENSG00000068323 |
| ENSG00000147889 | ENSG00000147889 |
| ENSG00000149948 | ENSG00000100814 |
| ENSG00000149948 | ENSG00000144476 |
| ENSG00000149948 | ENSG00000145012 |
| ENSG00000149948 | ENSG00000164919 |
| ENSG00000149948 | ENSG00000182185 |
| ENSG00000149948 | ENSG00000183722 |
| ENSG00000149948 | ENSG00000189283 |
| ENSG00000153201 | ENSG00000171094 |
| ENSG00000153814 | ENSG00000112511 |
| ENSG00000153814 | ENSG00000178691 |
| ENSG00000153944 | ENSG00000078399 |
| ENSG00000156650 | ENSG00000005339 |
| ENSG00000156976 | ENSG00000113916 |
| ENSG00000158715 | ENSG00000006468 |
| ENSG00000158715 | ENSG00000171656 |
| ENSG00000159216 | ENSG00000022556 |
| ENSG00000159216 | ENSG00000079102 |
| ENSG00000159216 | ENSG00000085276 |
| ENSG00000159216 | ENSG00000106346 |
| ENSG00000159216 | ENSG00000109686 |
| ENSG00000159216 | ENSG00000116251 |
| ENSG00000159216 | ENSG00000129993 |
| ENSG00000159216 | ENSG00000143373 |
| ENSG00000159216 | ENSG00000155313 |
| ENSG00000159216 | ENSG00000169946 |
| ENSG00000159216 | ENSG00000198492 |
| ENSG00000159216 | ENSG00000206115 |
| ENSG00000162367 | ENSG00000123473 |
| ENSG00000162775 | ENSG00000196588 |
| ENSG00000163902 | ENSG00000085276 |
| ENSG00000164692 | ENSG00000181690 |
| ENSG00000165288 | ENSG00000137727 |
| ENSG00000167460 | ENSG00000171094 |
| ENSG00000168036 | ENSG00000181690 |
| ENSG00000168421 | ENSG00000113916 |
| ENSG00000169306 | ENSG00000198947 |
| ENSG00000169696 | ENSG00000068323 |
| ENSG00000169714 | ENSG00000129204 |
| ENSG00000170791 | ENSG00000181690 |
| ENSG00000170881 | ENSG00000189283 |
| ENSG00000170961 | ENSG00000181690 |
| ENSG00000172660 | ENSG00000119508 |
| ENSG00000172660 | ENSG00000126746 |
| ENSG00000172660 | ENSG00000128656 |
| ENSG00000172660 | ENSG00000135605 |
| ENSG00000173757 | ENSG00000131759 |
| ENSG00000178104 | ENSG00000113721 |
| ENSG00000179362 | ENSG00000006468 |
| ENSG00000179583 | ENSG00000113916 |
| ENSG00000180843 | ENSG00000171094 |
| ENSG00000181163 | ENSG00000131759 |
| ENSG00000181163 | ENSG00000171094 |
| ENSG00000181163 | ENSG00000178053 |
| ENSG00000182158 | ENSG00000132170 |
| ENSG00000182944 | ENSG00000006468 |
| ENSG00000182944 | ENSG00000100105 |
| ENSG00000182944 | ENSG00000118260 |
| ENSG00000182944 | ENSG00000119508 |
| ENSG00000182944 | ENSG00000123268 |
| ENSG00000182944 | ENSG00000126746 |
| ENSG00000182944 | ENSG00000135605 |
| ENSG00000182944 | ENSG00000151702 |
| ENSG00000182944 | ENSG00000157554 |
| ENSG00000182944 | ENSG00000163497 |
| ENSG00000182944 | ENSG00000166986 |
| ENSG00000182944 | ENSG00000175197 |
| ENSG00000182944 | ENSG00000175832 |
| ENSG00000182944 | ENSG00000184937 |
| ENSG00000182944 | ENSG00000204531 |
| ENSG00000184012 | ENSG00000006468 |
| ENSG00000184012 | ENSG00000157554 |
| ENSG00000184012 | ENSG00000171656 |
| ENSG00000184012 | ENSG00000175832 |
| ENSG00000184402 | ENSG00000126752 |
| ENSG00000184507 | ENSG00000141867 |
| ENSG00000185811 | ENSG00000113916 |
| ENSG00000186716 | ENSG00000077782 |
| ENSG00000186716 | ENSG00000096968 |
| ENSG00000186716 | ENSG00000097007 |
| ENSG00000186716 | ENSG00000134853 |
| ENSG00000187735 | ENSG00000181690 |
| ENSG00000188580 | ENSG00000139083 |
| ENSG00000189283 | ENSG00000149948 |
| ENSG00000189283 | ENSG00000170881 |
| ENSG00000196092 | ENSG00000139083 |
| ENSG00000196531 | ENSG00000113916 |
| ENSG00000196535 | ENSG00000077782 |
| ENSG00000197323 | ENSG00000165731 |
| ENSG00000197711 | ENSG00000048544 |
| ENSG00000198339 | ENSG00000113916 |
| ENSG00000204691 | ENSG00000112561 |

wherein gene A is the upstream fusion gene partner of the fusion gene and gene B is the downstream fusion gene partner of the fusion gene.

22. The microarray of claim 1, wherein said microarray comprises a chimeric probe for at least 20% of the possible intergenic exon-to-exon junctions of the fusion gene.

23. The microarray of claim 1, wherein said microarray comprises a chimeric probe for each possible intergenic exon-to-exon junction of the fusion gene.

24. The microarray of claim 1, wherein said microarray comprises chimeric probes for all the fusion genes listed in claim 21.

25. The microarray of claim 1, wherein the chimeric probes comprise a first part and a second part, wherein the first part corresponds to the 3′ end of an exon of an upstream fusion gene partner and a second part corresponds to 5′ end of a downstream fusion gene partner, and wherein said chimeric probes are either antisense probes oriented to hybridise to mRNA or cDNA or sense probes being oriented to hybridise to cDNA of the fusion genes.

26. The microarray of claim 1, wherein said microarray comprises both antisense and sense probes for each intergenic exon-to-exon junction.

27. The microarray of claim 1, wherein the chimeric probes are adjusted in length to have a Tm value that differs by at most 5 degrees Celsius.

28. The microarray of claim 1, wherein the first part and the second part of the chimeric probes are adjusted in length to have a Tm value that differs at most 5 degree Celsius.

29. The microarray of claim 1, wherein the Tm value of the chimeric probes are above the temperature used for hybridisation and wherein the Tm of upstream or downstream parts of the chimeric probes is below the temperature used for hybridisation.

30. The microarray of claim 1, further comprising chimeric probes targeting single nucleotide polymorphic (SNP) variants of exon-to-exon junctions.

31. A method of detecting a fusion gene comprising:
(a) providing a sample;
(b) isolating RNA from the sample;
(c) detecting exon-to-exon junctions of mRNAs or cDNA from the sample using a microarray according to claim 1, thereby identifying the fusion gene present in the sample.

32. The method of claim 31, wherein the detection is performed without performing reverse transcriptase polymerase chain reaction (RT-PCR) on the RNA or polymerase chain reaction (PCR) on cDNA obtained in step (b) prior to detection of the fusion gene with a microarray.

33. The method of claim 31, wherein the chimeric probe and the at least two intragenic probes in step (c) are present on the same microarray.

34. The method of claim 31, further comprising preparation of cDNA using either oligo-dT priming or random primers.

35. A kit comprising a microarray that comprises a chimeric probe for an intergenic exon-to-exon junction of a fusion gene, wherein said microarray comprises at least two intragenic probes for a fusion gene partner and random primers for cDNA synthesis or oligo-dT primers for cDNA synthesis, and wherein the intragenic probes are either sense or antisense probes.

36. The kit according to claim 35, wherein the chimeric probe and the at least two intragenic probes in step (c) are present on the same microarray.
